(19) United States
(12) Patent Application Publication
(10) Pub. No.: US 2016/0212467 A1
(43) Pub. Date: Jul. 21, 2016

(54) APPARATUS AND METHOD FOR INTEGRATING AND PLAYING BACK SUB-CONTENT BASED ON INFORMATION ABOUT MAIN CONTENT IN MULTI-PROJECTION SCREENING ENVIRONMENT

(71) Applicant: CJ CGV CO., LTD., Mapo-gu, Seoul (KR)

(72) Inventors: Ji Hyung KANG, Hwaseong-si, Gyeonggi-do (KR); Soo Jin KIM, Goyang-si, Gyeonggi-do (KR); Ine Hye PARK, Seoul (KR); Dan Bee LEE, Seoul (KR); Su Ryeon KANG, Goyang-si, Gyeonggi-do (KR)

(21) Appl. No.: 14/897,598

(22) PCT Filed: Aug. 20, 2015
(86) PCT No.: PCT/KR2015/008693

§ 371 Date: Dec. 10, 2015

(30) Foreign Application Priority Data
Aug. 22, 2014 (KR) 10-2014-0109725

(51) Int. Cl. H04N 21/2665; H04N 21/262; H04N 21/41; H04N 9/31

(52) U.S. Cl. CPC H04N 21/2665; H04N 9/31; H04N 21/26241; H04N 21/26283; H04N 21/4122

(57) ABSTRACT

Disclosed herein is the playback of content in a multi-projection theater equipped with a plurality of projection surfaces. More particularly, the present invention relates to obtaining content information about main content from screening-related apparatuses, obtaining organization information about the main content from an external server, and generating a single time line by mapping the content information to the organization information. The generated time line is used to determine the playback schedule of sub-content to be played back in auxiliary projection surfaces of a plurality of projection surfaces. The present invention relates to an integration playback apparatus and integration playback method for organically integrating and playing back main content and sub-content in a multi-projection screening environment.

### TECHNICAL FIELD

The present invention relates to the playback of content in a multi-projection theater including a plurality of projection surfaces. More particularly, the present invention relates to obtaining content information about main content from screening-related apparatuses, obtaining organization information about the main content from an external server, and generating a single time line by mapping the content information to the organization information. The generated time line is used to determine the playback schedule of sub-content to be played back in auxiliary projection surfaces of a plurality of projection surfaces. The present invention relates to an integration playback apparatus and integration playback method for organically integrating and playing back main content and sub-content in a multi-projection screening environment.

### BACKGROUND ART

In line with the growth of the movie content market, research continues to be made in order to provide a screening environment having a good feeling of immersion using a plurality of projection surfaces, unlike in the screening of content based on a single screen within a theater. As a result, a multi-projection theater further including auxiliary projection surfaces on both sides of a front projection surface in addition to the front projection surface has reached commercialization.

However, most of movie content produced so far is played back in a single screen. Accordingly, theaters equipped with a plurality of projection surfaces are problematic in that a main screen and sub-screens are not efficiently used.

In particular, if a content producer completes movie content and provides the movie content to theaters through a distributor, operators who manage the theaters are unable. to change or modify the content itself and have to play back the original content itself in a single screen. Accordingly, the operators do not efficiently use sub-screens.

Some content producers, distributors, and theater operators include a plurality of security contents for preventing the leakage of content in a contract. If an operator who manages a theater wants to play back provided movie content, the operator has to ingest a digital cinema package (DCP) in a content playback server (or cinema server). Furthermore, when the movie content is played back, a strict security solution, such as authentication using a key delivery message (KDM), is required, thereby making it difficult to obtain meta information about the movie content itself. For this reason, in the case of content produced for a single screen, meta information, in particular, organization information, such as a content start time and a content end time, cannot be obtained. As a result, there is a problem in that sub-content cannot be organically played back in association with the corresponding content according to the progress of the corresponding content because the time line of the corresponding content is unknown.

The present invention has been made to solve such a problem in that sub-content cannot be organically played back in association with main content because meta information about the main content cannot be easily obtained. The present invention has been invented to satisfy the aforementioned technical requirements and to provide additional technical elements which may not be easily invented by those skilled in the art.

### DISCLOSURE OF INVENTION

### Technical Problem

An object of the present invention is to play back sub-content associated with main content through auxiliary projection surfaces when the main content is played back in a single screen.

In particular, an object of the present invention is to accurately check the time line of main content by collecting the first data of the main content from screening-related apparatuses included in a theater, for example, a projector, a content playback server, and an audible device and collecting second data related to the main content from external servers, for example, a web server.

Another object of the present invention is to integrate and play back main content and sub-content by setting the playback schedule of the sub-content so that the sub-content is played back on a time line in association with the main content after the time line of the main content is clearly defined.

### Solution to Problem

In an aspect of the present invention, a content integration playback method includes obtaining first data based on the signal of main content obtained from a plurality of screening-related apparatuses, collecting second data related to the main content from an external server, generating the time line of the main content based on the first data and the second data, setting the playback schedule of sub-content on the time line, and displaying the sub-content in auxiliary projection surfaces based on the set playback schedule.

Furthermore, in the content integration playback method, the screening-related apparatuses include at least one of a projector, a content playback server, and an audible device.

Furthermore, in the content integration playback method, the first data of the main content includes a total running time and a current playback time.

Furthermore, in the content integration playback method, the second data may include organization information about the main content.

Furthermore, in the content integration playback method, the sub-content may include any one of text, an image, and a moving image.

Furthermore, in the content integration playback method, obtaining the first data may include collecting analog signals from the plurality of screening-related apparatuses and converting the analog signals into the first data of a digital format capable of being processed by the content integration playback apparatus.

In another aspect of the present invention, a content integration playback apparatus in a multi-projection theater includes an information collection unit configured to collect the signal of main content from screening-related apparatuses, obtain the first data using the signal, and collect second data including organization information about the main content from an external server, a playback schedule operation unit configured to generate the time line of the main content by combining the first data and the second data and set the playback schedule of sub-content in the time line, a content DB configured to store the sub-content, and a control unit configured to control the information collection unit, the playback schedule operation unit, and the content DB.

Furthermore, the content integration playback apparatus may further include a data conversion unit configured to convert the signal collected from the screening-related apparatuses into the first data capable of being processed by the playback schedule operation unit.

### Advantageous Effects of Invention

In accordance with an embodiment of the present invention, there is an advantage in that sub-content and main content can be integrated and played back according to an accurate time line in association with the main content when the main content is played back.

Furthermore, in accordance with an embodiment of the present invention, there is an advantage in that an environment in which an entity which provides a theater service can provide various services to the audience because sub-content associated with main content can be freely generated.

Furthermore, in accordance with an embodiment of the present invention, there is an advantage in that more abundant visual information can be provided to the audience because auxiliary projection surfaces can be used when main content produced for only a single screen is played back.

### BRIEF DESCRIPTION OF DRAWINGS

FIG. 1 schematically illustrates a content integration playback method in accordance with an embodiment of the present invention in a flow of sequence;

FIG. 2 is a block diagram showing a detailed configuration of a content integration playback apparatus in accordance with an embodiment of the present invention;

FIG. 3 illustrates information about a total running time and current playback time obtained from collected first data;

FIG. 4 illustrates second data that is a collection object;

FIG. 5 illustrates a time line generated based on first data and second data and the playback schedule of sub-content set on the time line;

FIG. 6 shows an example in which sub-content is played back in auxiliary projection surfaces in association with main content when the introduction part of the main content is played back;

FIG. 7 illustrates sub-content played back in association with main content when the main content is played back;

FIG. 8 shows an example in which sub-content is played back in association with main content when the ending credit of the main content is played back; and

FIG. 9 shows an example of a multi-projection theater that is the premise of an embodiment of the present invention.

### MODE FOR THE INVENTION

The details of the objects and technical configurations of the present invention and corresponding acting effects will become more clearly understood from the following detailed description based on the drawings accompanied by the specification of the present invention. Hereinafter, embodiments of the present invention are described in detail with reference to the accompanying drawings.

Embodiments disclosed in this specification should not be interpreted or used as limiting the scope of the present invention. It is evident to those skilled in the art that a description including the embodiments of this specification may have various applications. Accordingly, some embodiments of the present invention described in the detailed description of the present invention are illustrative for a better description, and the scope of the present invention is not intended to be limited to the embodiments.

Functional blocks illustrated in the drawings and described below are only examples of possible implementations. In other implementations, different functional blocks may be used without departing from the spirit and scope of the detailed description. Furthermore, although one or more functional blocks of the present invention are indicated as separate blocks, one or more of the functional blocks of the present invention may be a combination of various hardware and software elements executing the same function.

Furthermore, it should be understood that an expression that some elements are “included” is an expression of an “open type” and the expression simply denotes that the corresponding elements are present, but does not exclude additional elements.

Furthermore, when one element is described as being “connected” or “coupled” to the other element, it should be understood that one element may be directly connected or coupled to the other element, but a third element may be interposed between the two elements.

A content integration playback apparatus 200 in accordance with an embodiment of the present invention may be a server managed by a theater service operator

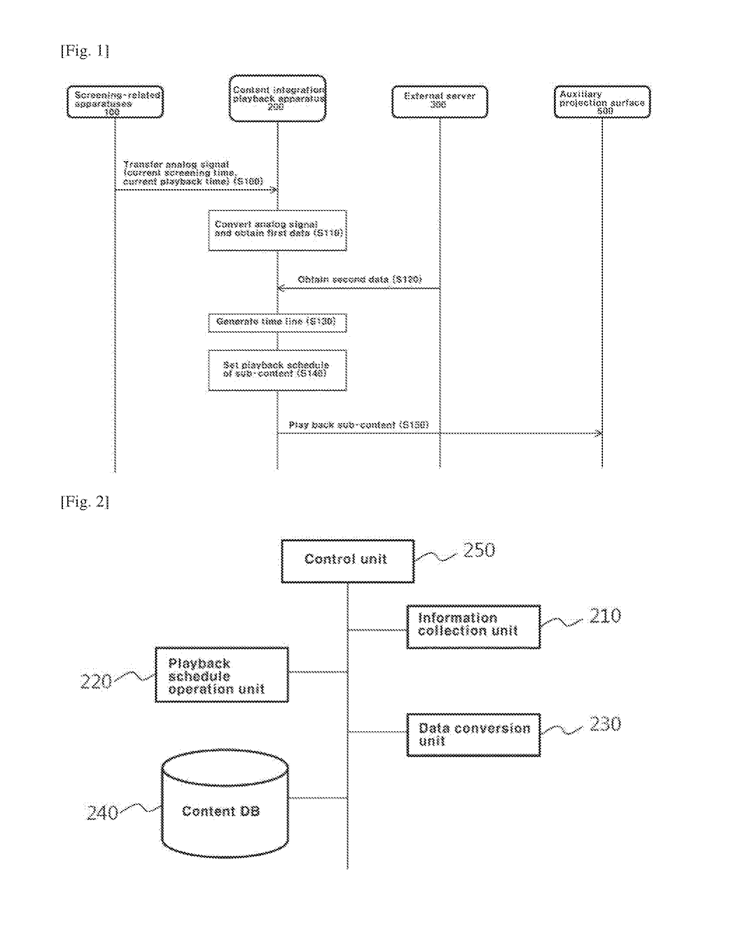

A content integration playback method in accordance with an embodiment of the present invention is described in detail below with reference to FIGS. 1 and 2.

Prior to a description of sequence of steps, a multi-projection theater system that is, the premise of an embodiment of the present invention, is described in brief.

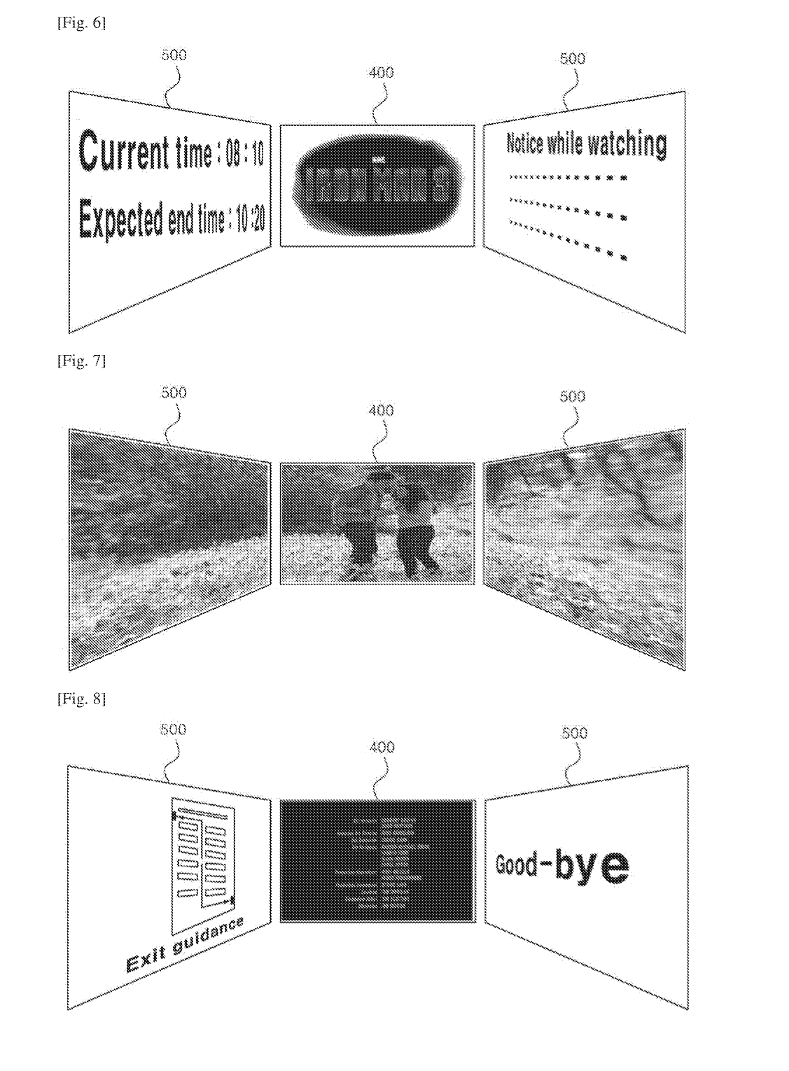

The multi-projection theater system, that is, the premise of an embodiment of the present invention, basically includes screening-related apparatuses 100 which are related to the screening of main content, such as the playback of a movie, projection, and sound output. Furthermore, the multi-projection theater system may further include auxiliary projection surfaces 500 on the right and left of a main screen 400 in addition to the main screen 400 at the front of a theater. In this case, the auxiliary projection surfaces 500 may be implemented as separate screens independently of the main screen 400, but the inner wall of a theater building may be used as the auxiliary projection surfaces 500. The ceil and bottom of the theater building may also be used as the auxiliary projection surfaces 500 in addition to the inner wall of the theater building. FIG. 7 shows a schematic configuration of a multi-projection theater that is the premise of an embodiment of the present invention. From FIG. 7, it may be seen that the main screen 400 at the front and the auxiliary projection surfaces 500 on both sides of the main screen 400 have been implemented.

The multi-projection theater system, that is, the premise of an embodiment of the present invention, may also be connected to a server outside a theater. In this case, the external server 300 is connected to the content integration playback apparatus 200 in accordance with an embodiment of the present invention over a wired or wireless network and may be connected to various web servers outside the theater.

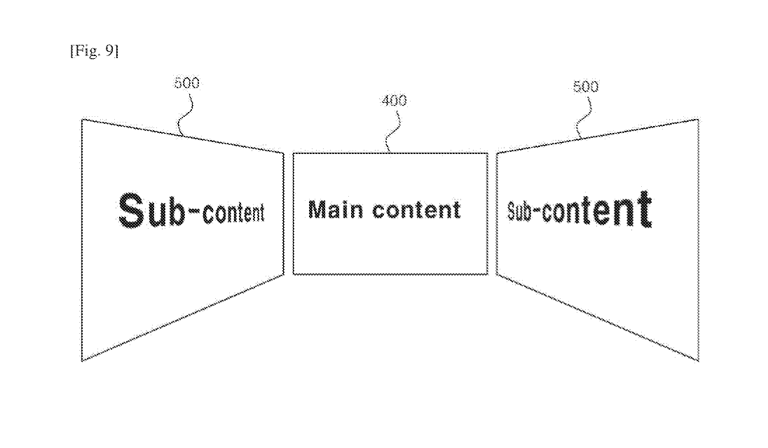

FIG. 9 shows a front screen in which main content is played back and the auxiliary projection surfaces 500 in which sub-content is played back. The content integration playback apparatus 200 and the content integration playback method in accordance with embodiments of the present invention are described in detail below on the premise of the multi-projection theater system schematically described above.

FIG. 1 schematically illustrates the content integration playback method in accordance with an embodiment of the present invention in a flow of sequence, and FIG. 2 is a block diagram showing a detailed configuration of the content integration playback apparatus in accordance with an embodiment of the present invention.

Referring to FIG. 1, the content integration playback method includes first collecting first data and second data regarding main content that is being played back at step S100 to step S120. Such steps are performed by the information collection unit 210 of the content integration playback apparatus 200.

The first data includes basic metadata regarding the main content that is being played back, that is, a movie. The first data may be collected from the screening-related apparatuses 100 within a theater, for example, a content playback projector, a content playback server, and an audible device.

The first data collected from the screening-related apparatuses 100 has an analog data format not a digital data format. The reason for this is that data of a digital format cannot be directly received from the screening-related apparatuses 100 according to various solutions which have been introduced to prevent the leakage of main content. Analog data, for example, source data, such as analog sound time code of an SMPTE format, is collected from the screening-related apparatuses 100. The analog data is converted into data of a digital format which can be processed by the content integration playback apparatus 200. The data of a digital format is used as the first data for generating the time line of the main content at step S110. In this case, in order to convert the analog data into the data of a digital format, content integration playback apparatus 200 in accordance with an embodiment of the present invention may further include a data conversion unit 230.

The first data collected as described above may include information about the total running time and current playback time of the main content. That is, the content integration playback apparatus 200 may obtain information regarding that current main content has a total of how many running time and that the main content has been played back for how many minutes so far based on the collected first data.

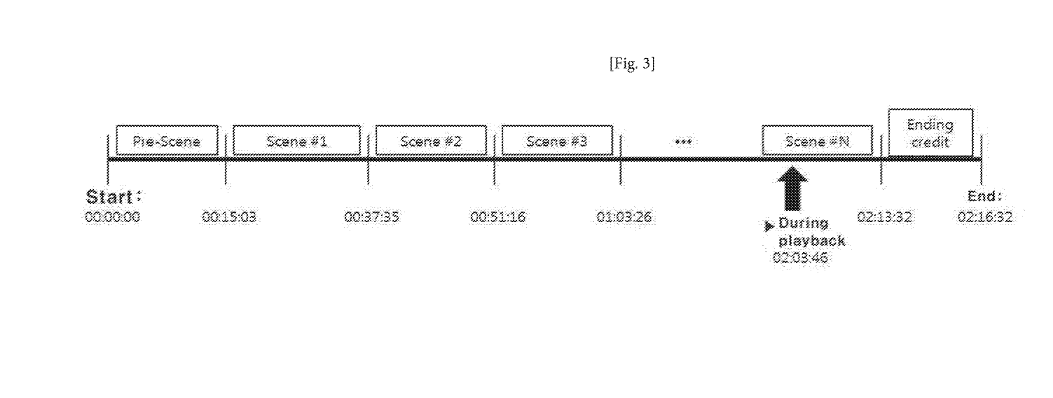

FIG. 3 illustrates information about a total running time and current playback time obtained from collected first data. From FIG. 3, information regarding that main content is played back at which point of elements, that is, an advertisement (e.g., pre-scene), a plurality of scenes, and an ending credit, may be seen based on first data when a piece of the main content is played back.

The second data means information relating to the main content. A difference between the second data and the first data is that the second data is collected from servers outside a theater. That is, if the first data has been collected from the screening-related apparatuses 100 within a theater, the second data is for obtaining information which may not be obtained from the first data and may be obtained from a web server capable of accessing massive information.

Unlike in the screening-related apparatuses 100 affecting a security solution, information may be freely collected from the external servers 300. The type of second data collected as described above may include information related to main content that is being played back in a specific theater, for example, organization information about the main content (e.g., the start time and end time of the main content and information regarding that which part of the main content is being played at what point of time). The second data has a digital data format unlike the first data.

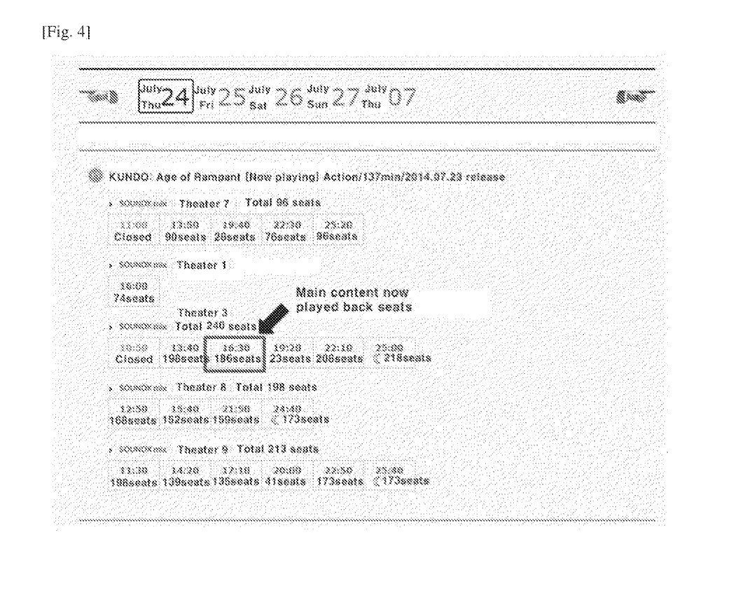

FIG. 4 illustrates second data that is a collection object.

As shown in FIG. 4, information regarding that “KUNDO: Age of the Rampant”, that is, main content that is being played back in Theater 3, was started at 16:30 may be obtained.

That is, the content integration playback apparatus 200 collects information about main content that is being played back in a specific theater and about the start time of the main content in a digital format through a web server, that is, the Internet, as described above.

After both the first data and the second data are collected, the playback schedule operation unit 220 of the content integration playback apparatus 200 generates a single time line by combining the first data and the second data at step S130.

The time line means that the start time, end time, total running time, and playback time of each scene of main content that is being played back or that is to be played in the future have been determined based on a single time reference line.

That is, the content integration playback apparatus 200 generates the time line of the main content by combining the information about the total running time and current playback time obtained from the first data and the organization information about the main content obtained from the second data.

Referring to the examples of FIGS. 3 and 4, the content integration playback apparatus 200 may recognize that the main content, that is, “KUNDO: Age of the Rampant”, was started at 16:30 and is being played back from the collected second data, recognizes a total running time of the main content is 2 hours, 16 minutes, 32 seconds (2:16:32) and 2 hours, 3 minutes, 46 seconds (13:46) has elapsed from the start time based on the first data, and generates a single time line for the main content.

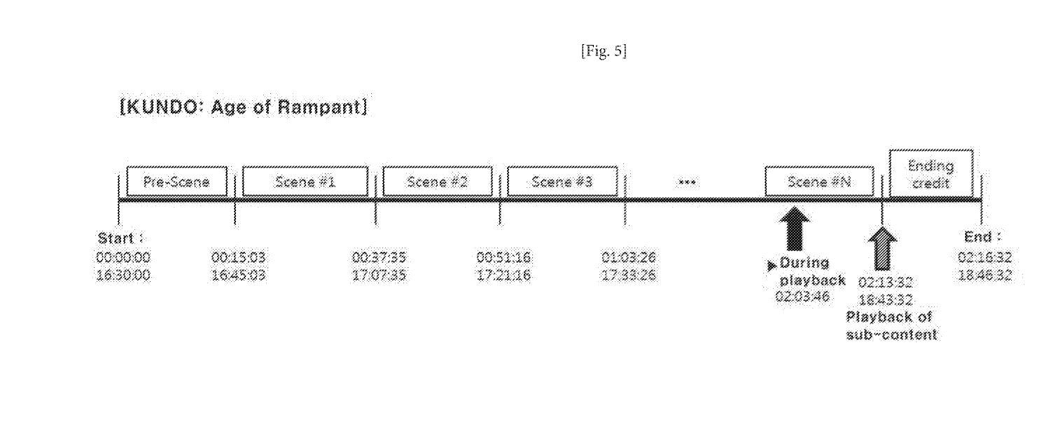

After the time line of the main content is generated, the playback schedule operation unit 220 of the content integration playback apparatus 200 configures that sub-content previously stored in a content DB 240 in accordance with the main content will be played back at which point of time, that is, sets the playback schedule of the sub-content at step S140. It is not difficult to set a point of time at which the sub-content associated with the main content will be played back because the time line of the main content has been generated. FIG. 5 illustrates the time line generated based on the first data and the second data and the playback schedule of the sub-content set on the time line.

The sub-content played back in association with the main content may be produced in various ways, such as screens including text, an image, and a moving image. Furthermore, the sub-content may have been newly produced or may have been collected by downloading previously implemented content from the external servers 300.

After the playback schedule of pieces of the sub-content is set on the time line, the content integration playback apparatus 200 plays back the pieces of sub-content in the auxiliary projection surfaces 500 based on the generated time line of the main content and the playback schedule of the pieces of sub-content set on the time line at step S150.

A process of integrating and playing back the main content and the sub-content has been described above with reference to FIGS. 1 and 2. The content integration playback apparatus 200 for performing such a process may further include a control unit 250 for controlling internal functional units, that is, the information collection unit 210, the playback schedule operation unit 220, the data conversion unit 230, and the content DB 240.

In this case, the control unit 250 may include at least one operation device. The operation device may be a general-purpose central processing unit (CPU), a programmable device (CPLD or FPGA) suitably implemented for a special purpose, an application-specific integrated circuit (ASIC), or a microcontroller chip.

An embodiment in which main content and sub-content are associated and played back in an actual multi-projection theater in accordance with the content integration playback method is described below with reference to FIGS. 6 to 8.

First, FIG. 6 shows an example in which sub-content is played back in the auxiliary projection surfaces 500 in association with main content when the introduction part of the main content is played back.

Referring to FIG. 5, the content integration playback apparatus 200 may recognize the end time of a pre-scene, including an advertisement or an evacuation route in emergency, and the start time (16:45:03) of the main content based on the generated time line and provide sub-content associated with the corresponding point of time at which the main content is played back. FIG. 6 shows an example in which a current time, time when the playback of the corresponding content is expected to be ended, and notes while watching are provided to the audience in text form through the auxiliary projection surfaces 500 when the introduction part of the main content is started.

If the sub-content is played back in association with the introduction part of the main content as in FIG. 6, a problem in that the concentration of the audience is not sufficiently induced when pre-scenes are played back in a conventional single screen can be overcome. Accordingly, an advertisement effect and a notice effect can be doubled.

FIG. 7 illustrates sub-content played back in association with main content when the main content is played back.

That is, the content integration playback apparatus 200 may recognize the playback time of each scene of content and set the playback schedule of sub-content corresponding to each scene. Although main content itself has been produced for a single screen, a user can produce separate sub-content associated with the main content and play back the produced sub-content at a desired point.

The sub-content may have been produced based on a corresponding frame of the main content that is being played back or may be content which has been received from the external server 300.

FIG. 8 shows an example in which sub-content is played back in association with main content when the ending credit of the main content is played back.

In this case, the content integration playback apparatus 200 in accordance with an embodiment of the present invention may recognize time (e.g., a point of time 18:43:32 in FIG. 5) when the ending credit is played back and play back sub-content in which the playback schedule has been set in the corresponding point. In this case, the sub-content that is played back may include an exit guidance notice for the audience and a message as shown in FIG. 8 and may be freely produced by a person who uses the present invention, such as an operator who manages a theater.

Although some embodiments and applications of the present invention have been illustrated and described above, the present invention is not limited to the aforementioned specific embodiments and applications, and those skilled in the art to which the present invention pertains may modify the present invention in various ways without departing from the gist of the present invention written in the claims. Such modified embodiments should not be interpreted as being distinct from the technical spirit or prospect of the present invention.

1. A content integration playback method performed by a content integration playback apparatus, comprising:
obtaining first data based on a signal of main content obtained from a plurality of screening-related apparatuses;
collecting second data related to the main content from an external server;
generating a time line of the main content based on the first data and the second data;
setting a playback schedule of sub-content on the time line; and
displaying the sub-content in auxiliary projection surfaces based on the set playback schedule.

2. The content integration playback method of claim 1, wherein the screening-related apparatuses comprise at least one of a projector, a content playback server, and an audible device.

3. The content integration playback method of claim 1, wherein the first data of the main content comprises a total running time and a current playback time.

4. The content integration playback method of claim 1, wherein the second data comprises organization information about the main content.

5. The content integration playback method of claim 1, wherein the sub-content comprises any one of text, an image, and a moving image.

6. The content integration playback method of claim 1, wherein obtaining the first data comprises:
collecting analog signals from the plurality of screening-related apparatuses; and
converting the analog signals into the first data of a digital format capable of being processed by the content integration playback apparatus.

7. A content integration playback apparatus in a multi-projection theater, comprising:
an information collection unit configured to collect a signal of main content from screening-related apparatuses, obtain the first data using the signal, and collect second data comprising organization information about the main content from an external server;
a playback schedule operation unit configured to generate a time line of the main content by combining the first data and the second data and set a playback schedule of sub-content in the time line;
a content DB configured to store the sub-content; and
a control unit configured to control the information collection unit, the playback schedule operation unit, and the content DB.

8. The content integration playback apparatus of claim 7, further comprising a data conversion unit configured to convert the signal collected from the screening-related apparatuses into the first data capable of being processed by the playback schedule operation unit.
